(19) United States
(12) Patent Application Publication
(10) Pub. No.: US 2018/0322768 A1
(43) Pub. Date: Nov. 8, 2018

(54) Wearable Electronic Device Alerts

(71) Applicant: Lenovo (Singapore) Pte. Ltd., Singapore (SG)

(72) Inventors: Timothy W. Kingsbury, Cary, NC (US); Robert J. Kapinos, Durham, NC (US); Scott W. Li, Cary, NC (US); Russell S. VanBlon, Raleigh, NC (US)

(21) Appl. No.: 15/587,624

(22) Filed: May 5, 2017

(51) Int. Cl. G08B 21/24; H04B 1/3827

(52) U.S. Cl. CPC G08B 21/24; H04B 2001/3855; H04B 1/385

(57) ABSTRACT

An approach is provided that determines that a wearable electronic device is in a misplaced condition. In response to determining that the wearable electronic device is in a misplaced condition, the approach transmits an alert regarding the misplaced condition.

### BACKGROUND

It is common for users of wearable devices to clip the device to their clothing. If the user changes clothes, it's easy to fail to transfer the device to the new set of clothing. The wearable device might be left behind or it might be mistakenly left attached to the previous set of clothing. This can prevent the user from accurately tracking their activity. In some cases, the wearable device might actually end up in a clothes washing machine.

### SUMMARY

An approach is provided that determines that a wearable electronic device is in a misplaced condition. In response to determining that the wearable electronic device is in a misplaced condition, the approach transmits an alert regarding the misplaced condition.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages will become apparent in the non-limiting detailed description set forth below.

### BRIEF DESCRIPTION OF THE DRAWINGS

This disclosure may be better understood by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3A is a diagram depicting a user at a first location currently wearing a wearable electronic device and walking in a direction;

FIG. 3B is a diagram depicting the same user having dropped the wearable electronic device at the first location and moved to a second location with the electronic device notifying the user;

FIG. 4 is a flowchart showing steps performed during a setup routine;

FIG. 5 is a flowchart showing steps performed that monitor whether a wearable device has been dropped or left behind by a user; and

FIG. 6 is a flowchart showing steps performed to notify the user that the wearable device has been dropped or left behind.

### DETAILED DESCRIPTION

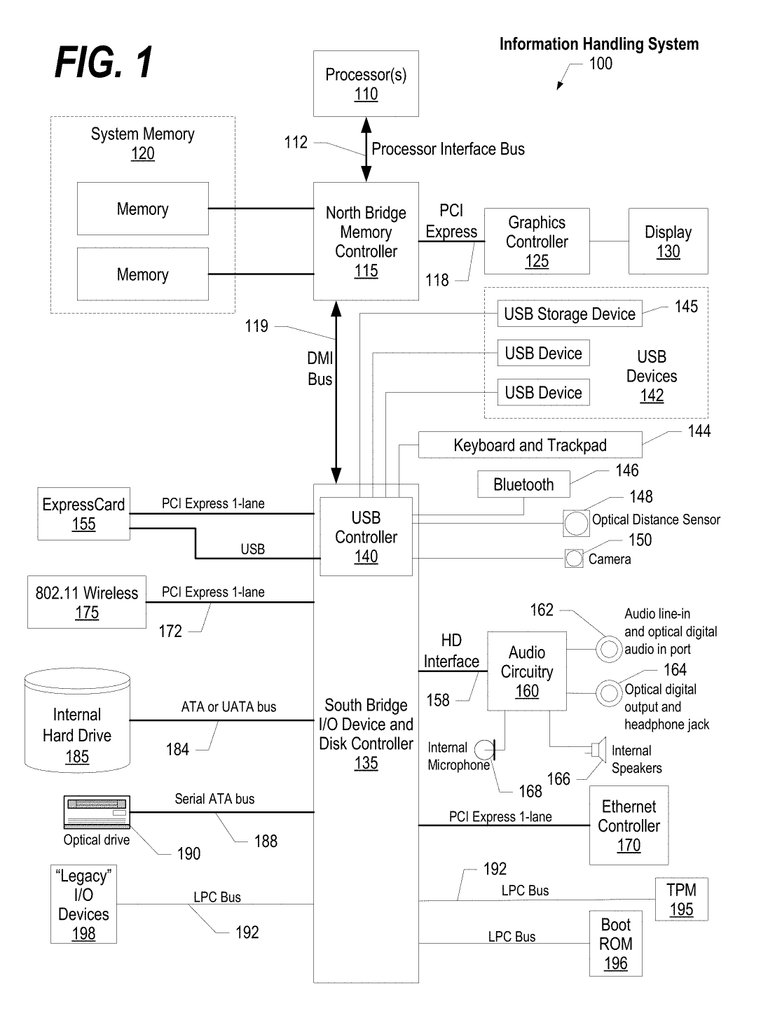

An approach is depicted in FIGS. 1-6 that shows monitoring typical usage patterns for a user's wearable device. On average, the user is always moving, at least a little bit, during waking hours. If the device completely stops moving during the time period when it is typically moving, then this is an indicator that the device is no longer being worn. If this situation is detected, the user can be warned in a variety of possible ways. Potential examples include: (1) a simple notification sound that is played shortly after the device has stopped moving. Optionally, this alarm may continue to play periodically if the device remains still. (2) Notifications may be sent to the user using other means, such as email or text messages. (3) Specific locations can be established by the user as being acceptable (or unacceptable) places to leave the device. Locations could be recognized by wireless triangulation, GPS, or other means. (4) The wearable clip that holds the device to the user's clothing could have awareness of whether it is clipped or unclipped. If the device is clipped to clothing, but not moving, that would be an indication to warn the user that they removed their clothes and forgot to unclip the device.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon. Logic as used herein include actions and self-contained sequence of actions to be performed by digital circuits characterized by the technology underlying its logic gates as well as by one or more processors programmed to execute instructions that perform such actions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. As used herein, a computer readable storage medium does not include a computer readable signal medium.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

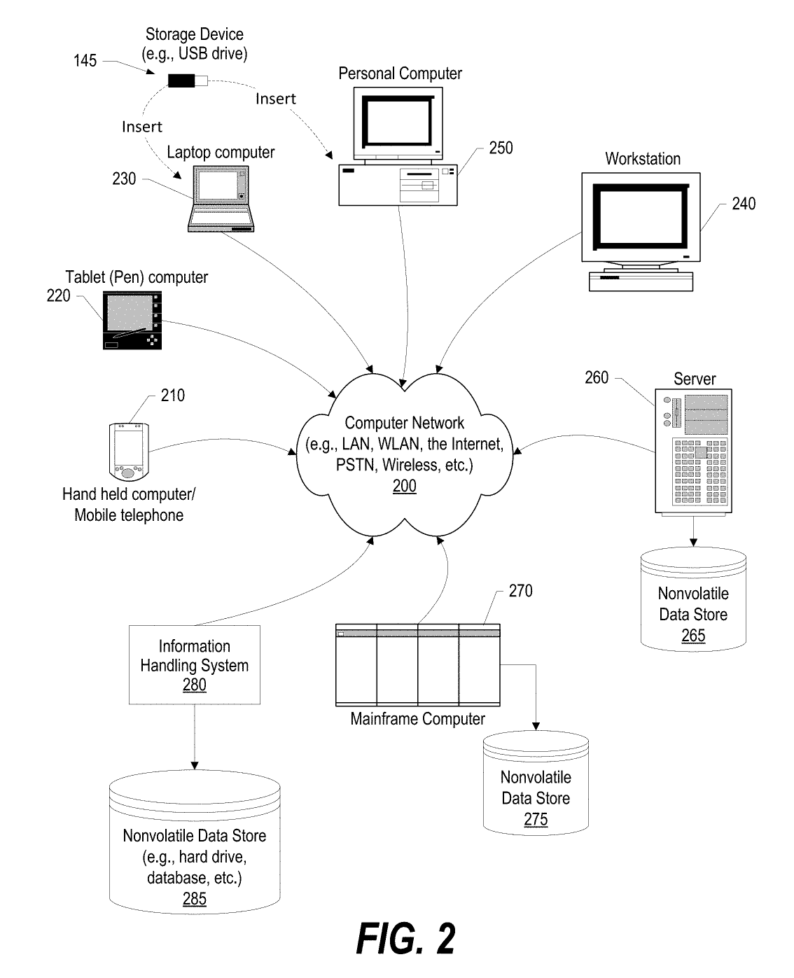

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include digital camera 150, optical distance sensor 148, keyboard and trackpad 144, and Bluetooth device 146, which provides for wireless personal area networks (PANs). Optical distance sensor 148 can detect the distance from a device to various objects, such as users of the system, while digital camera 150 can be used to capture images of objects, such as users of the system, to enable recognition software, such as facial recognition software, to identify the users of the system. USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

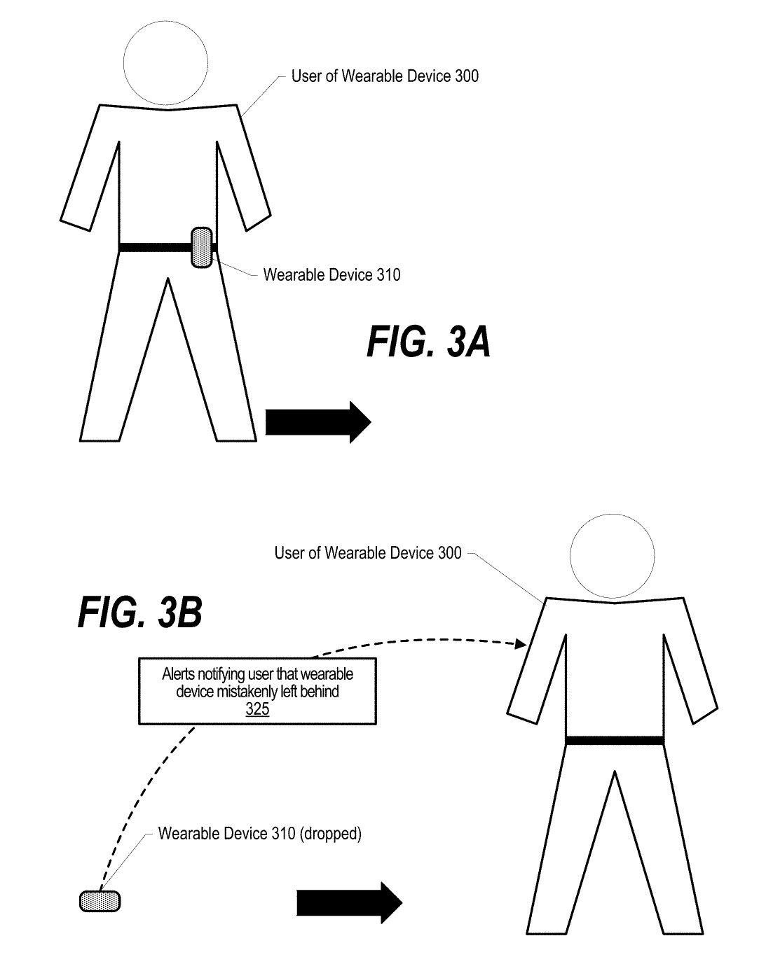

FIG. 3A is a diagram depicting a user at a first location currently wearing a wearable electronic device and walking in a direction. User 300 is depicted as having wearable electronic device 310 attached to the user's clothing so that the wearable electronic device moves as the user moves. A time threshold can be established so that an amount of time that the wearable electronic device remains stationary is compared to the threshold before a misplaced condition is triggered. Wearable electronic device 310 can be in a holder, such as a mobile phone holder, or be clipped to the user's clothing, such as a clip used to attach the wearable electronic device or a holder to the user's belt. Movement of the wearable electronic device can be quite subtle, as might be found when the user is sitting or standing. Even when the user is sitting or standing, small movements occur when the user occasionally shifts positions.

In one embodiment, the user can predefine geographic locations where it is acceptable for the wearable electronic device to be stationary. These predefined geographic locations might include the user's home, office, or other place where the user routinely removes the wearable electronic device from the user's person, such as to charge the wearable electronic device. If the wearable electronic device is within one of the predefined locations, then the misplaced condition is inhibited even if the wearable electronic device is stationary. In the depiction, the user is shown moving in a certain direction.

FIG. 3B is a diagram depicting the same user that was shown in FIG. 3A having dropped the wearable electronic device at the first location and moved to a second location with the electronic device notifying the user. Here, user 300 is at the second location and has dropped or left wearable electronic device 310 behind. Because wearable electronic device 310 is no longer attached to the user, it is stationary which results in a misplaced condition that causes process 325 to occur that performs one or more alerts that are aimed at alerting user 300 that the user has left the wearable electronic device behind. For example, the user might have left the wearable electronic device on a table in a restaurant after using the device and setting it on the table. The user may have forgotten to pick up the device when standing up and starting to leave the restaurant, in which case the wearable electronic device alerts the user that the device has been left behind.

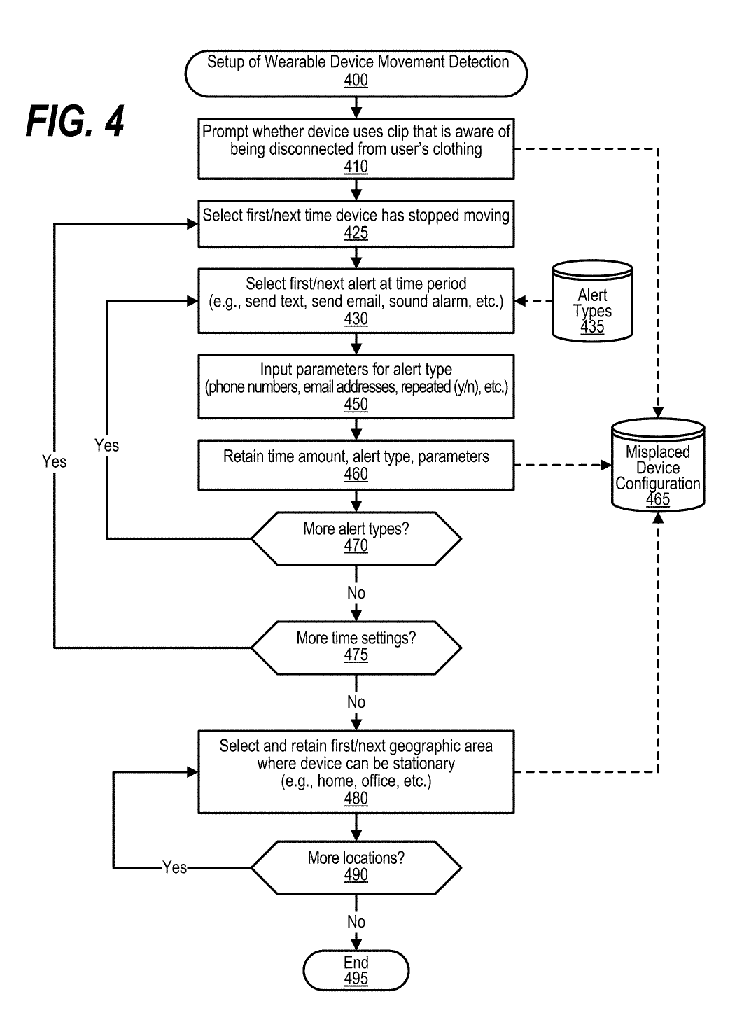

The alerts that occur when the misplaced condition is detected can include sounding an audible alarm at the wearable electronic device, transmitting a text message from the wearable electronic device to another device, transmitting a telephone call from the wearable electronic device to another device, transmitting an email message from the wearable electronic device to another device, and displaying a visible light at the wearable electronic device. These alerts can be repeated as needed. FIG. 4 shows the user setting up the features of the alerts including establishing which alerts to perform, whether they are repeated, as well as establishing predetermined geographic locations where the misplaced condition is inhibited, such as at the user's home.

In one embodiment, the wearable electronic device is in a holder with the wearable electronic device detecting that it has been removed from the holder and is stationary (rather than being held by the user), which triggers the misplaced condition and causes one or more alerts to be performed. In another embodiment, the wearable electronic device is attached to the user with a clip that attaches to the user's belt or other clothing. In this embodiment, when the clip senses that it is not attached to clothing and the device is stationary, the misplaced condition is triggered and one or more alerts are performed.

FIG. 4 is a flowchart showing steps performed during a setup routine. FIG. 4 processing commences at 400 and shows the steps taken by a process that performs a routine that sets up a wearable device movement detection parameters. At step 410, the setup process prompts the user whether device uses clip that is aware of being disconnected from user's clothing. The response from the user is retained in data store 465. At step 425, the user selects the first amount of time after which one or more alerts should be transmitted. For example, an audible alert might be configured after the wearable electronic device has been stationary for five seconds so that the user is likely to be within hearing range to hear the alert. At step 430, the user selects the alert that should be transmitted at the elapsed stationary time period selected at step 425. Selected alerts might include sending text message, send email messages, sounding an audible alarm at the device, transmitting a phone message, transmitting a visual alert at the device using a bright light at the device's screen, etc. In one embodiment, the available notification types are selected from data store 435.

At step 450, the user inputs any parameters that might be needed for the selected notification type, such as phone numbers to call or text, email addresses, and also whether the alert is repeated. For example, it might make sense to repeat an audible alarm or telephone message, but not to repeatedly send email messages to the same email address. At step 460, the setup process retains the time amount, the notification type, and the parameters that apply to the selected notification type in configuration file 465. The setup process determines as to whether there are more notification types that the user wishes to select from a user response (decision 470). If there are more notification types to process, then decision 470 branches to the ‘yes’ branch which loops back to step 430 to select the next notification type (alert) to use when the selected amount of time the wearable electronic device is stationary. This looping continues until there are no more notification types to process, at which point decision 470 branches to the ‘no’ branch exiting the loop.

The setup process next determines whether the user wishes to configure additional elapsed time settings (decision 475). If the user is configuring additional elapsed time settings, then decision 475 branches to the ‘yes’ branch which loops back to step 425 to select the next elapsed time amount from the user. This looping continues until no more elapsed time settings are being configured, at which point decision 475 branches to the ‘no’ branch exiting the loop.

At step 480, the setup process selects and retain the first geographic area where the wearable electronic device can be stationary without triggering a misplaced condition of the device. These locations might include the user's home, office, or anywhere the user routinely sets the wearable electronic device down in order to charge the device, etc. The geographic location data is retained in data store 465. The setup process determines whether there are additional geographic locations where it is permissible for the wearable electronic device to be stationary (decision 490). If there are more such geographic locations, then decision 490 branches to the ‘yes’ branch which loops back to step 480 to select and retain the next geographic location. This looping continues until there are no more geographic locations to process, at which point decision 490 branches to the ‘no’ branch exiting the loop. FIG. 4 processing thereafter ends at 495.

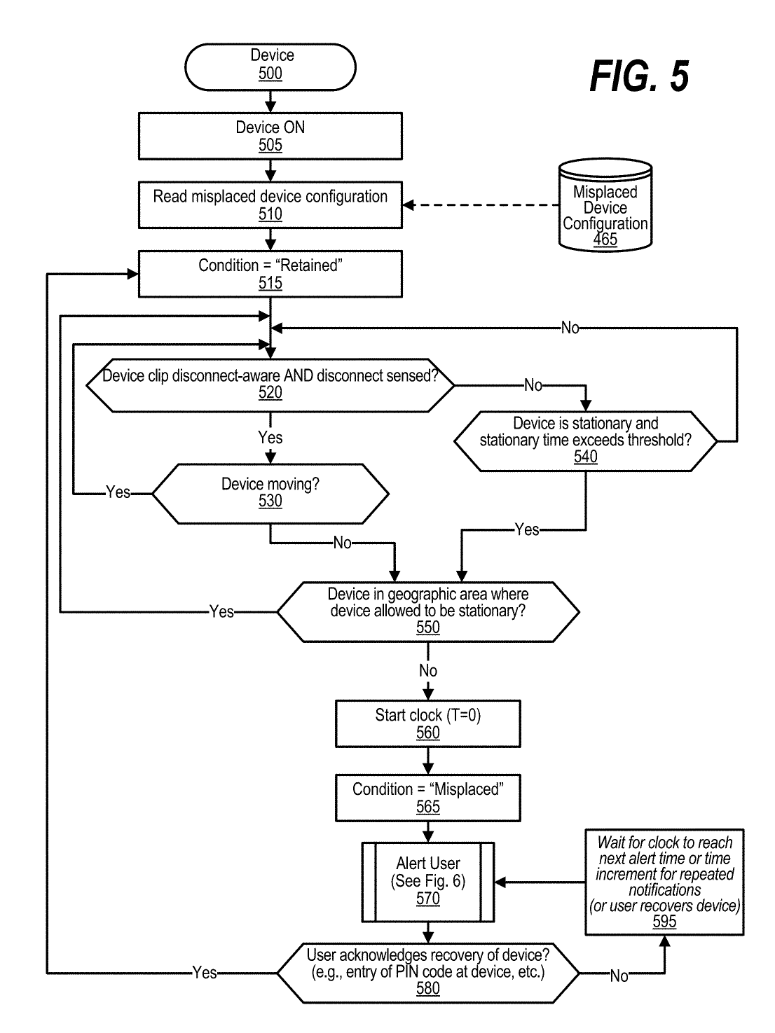

FIG. 5 is a flowchart showing steps performed that monitor whether a wearable device has been dropped, left behind by a user, or is otherwise stationary. FIG. 5 processing commences at 500 and shows the steps taken by a process that monitors a wearable electronic device and detects when the device is stationary and possibly triggers a misplaced condition whereupon a user of the device is alerted to the misplaced condition of the device. The process commences at 505 when the device is turned ON. At step 510, the process reads the misplaced device configuration from data store 465. At step 515, the condition of the device is set to “retained” signifying that the device is currently retained by, and in the possession of, the user.

The process determines as to whether the wearable electronic device has a clip or holder that is disconnect-aware AND whether the device has been sensed as being disconnected from the holder or the clip is no longer attaching the device to an article of clothing (decision 520). If both conditions are satisfied, then decision 520 branches to the ‘yes’ branch whereupon a determination is made as to whether any movement is detected at the device. If movement is detected at the device, then a misplaced condition has not been triggered and processing branches to the ‘yes’ branch that loops back to repeatedly test whether the wearable electronic device has been disconnected from its holder or if a clip attaching the device is no longer attached to an article of clothing. On the other hand, if the device is stationary, then decision branches to the ‘no’ branch to for further processing that determines whether to trigger a misplaced condition at the device that results in alerts being transmitted to notify the user.

Returning to decision 520, if the wearable electronic device is not using a device holder or a clip to attach the device to the user's clothing or if a disconnect of the device from the holder or clip has not been detected, then decision 520 branches to the ‘no’ branch whereupon a determination is made whether the device has been stationary for a predetermined time threshold, such as five seconds (decision 540). If the device has been stationary for longer than the predetermined threshold, then decision branches to the ‘yes’ branch to perform decision 550. On the other hand, if the device is moving or has not been stationary for the time threshold, then decision 540 branches to the ‘no’ branch which continues to loop back and monitor the movement of the device until the device is found to be stationary.

When the device is detected as being stationary then, at decision 550, the process determines whether the wearable electronic device is currently in a geographic area where the device is allowed to be stationary (decision 550), such as in the user's home, office, etc. If the device is in a geographic area where it is allowed to be stationary, then decision 550 branches to the ‘yes’ branch which loops back to continue monitoring the device movement and location. On the other hand, if the wearable electronic device is not in geographic area where it is allowed to be stationary, then decision 550 branches to the ‘no’ branch triggering a misplaced condition at the device. At step 560, the process starts a clock that keeps track of how long the wearable electronic device is in the misplaced condition. At step 565, the condition of the device is changed from “retained” to “misplaced,” signifying that the device has likely been misplaced by the user and prompting the system to transmits alerts to the user intended to allow the user to recover and retain the device.

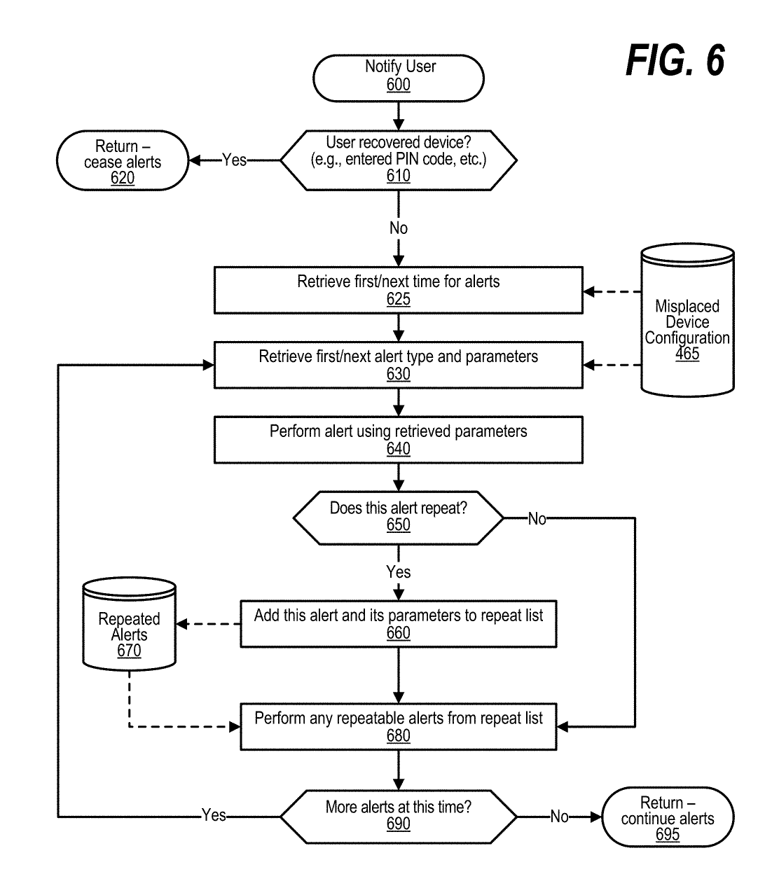

At predefined process 570, the process performs the Alert User routine (see FIG. 6 and corresponding text for processing details). The process determines whether the user has recovered the device and acknowledges recovery of the device, such as by entry of a PIN code at the device (decision 580). If the user acknowledges recovery of device, then decision 580 branches to the ‘yes’ branch which loops back to step 515 to reset the condition of the device back to “retained” with the process continuing the monitoring the device to detect if and when another misplaced condition is triggered. If the user does not acknowledge recovery of device, then decision 580 branches to the ‘no’ branch whereupon, at step 595, the process waits for clock to reach next alert time or time increment for repeated notifications (or until the user acknowledges recovery of the device). Predefined process 570 is repeated as needed until the wearable electronic device is recovered.

FIG. 6 is a flowchart showing steps performed to notify the user that the wearable device has been dropped or left behind. FIG. 6 processing commences at 600 and shows the steps taken by a process that alerts the user. This routine is called from the process shown in FIG. 5. The process determines whether the user has recovered the wearable electronic device (decision 610). If user has recovered the device, then decision 610 branches to the ‘yes’ branch whereupon, at 620 processing returns to the calling routine (see FIG. 5) with a return code indicating that the device has been recovered. On the other hand, if the user has not recovered the device, then decision 610 branches to the ‘no’ branch to perform steps 625 through 695.

At step 625, the process retrieves the first time for alerts from data store 465. At step 630, the process retrieves the first alert type and its parameters from data store 465. At step 640, the process performs the retrieved alert using the retrieved parameters. The process determines as to whether the alert is an alert that is repeated (decision 650). If the alert is an alert that is repeated, then decision 650 branches to the ‘yes’ branch whereupon, at step 660 the process adds this alert and its parameters to the repeat list that is stored in data store 670. On the other hand, if the alert is not an alert that is repeated, then decision 650 branches to the ‘no’ branch bypassing step 660.

At step 680, the process performs any repeatable alerts that are retrieved from the repeat list that is stored in data store 670. The process determines whether there are more alerts that are to be performed at this time (decision 690). If there are more alerts that are to be performed at this time, then decision 690 branches to the ‘yes’ branch which loops back to step 630 to retrieve and process the next alert as described above. This looping continues until there are no more alerts that are to be performed at this time, at which point decision 690 branches to the ‘no’ branch exiting the loop. At 620 processing returns to the calling routine (see FIG. 5) with a return code indicating that the device has not yet been recovered and that alerts should continue.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method comprising:
determining that a wearable electronic device is in a misplaced condition, wherein the determining includes detecting that the wearable electronic device is stationary for at least a predetermined amount of time; and
transmitting an electronic alert regarding the misplaced condition, wherein the electronic alert includes displaying a visible light beacon at the wearable electronic device.

2. The method of claim 1 further comprising:
identifying a geographic location of the wearable electronic device in response to the wearable electronic device becoming stationary;
comparing the identified geographic location with one or more predetermined acceptable geographic locations where a stationary device is acceptable;
inhibiting the misplaced condition in response to the wearable electronic device's identified geographic location corresponding to one of the predetermined acceptable geographic locations; and
establishing the misplaced condition in response to the wearable electronic device's identified geographic location failing to correspond to one of the predetermined acceptable geographic locations.

3. The method of claim 1 further comprising:
sensing that the wearable electronic device has been removed from a device holder; and
detecting that the wearable electronic device is stationary, wherein the determining that the wearable electronic device is in the misplaced condition is in response to the sensing and the detecting.

4. The method of claim 1 further comprising:
sensing that a clip used to attach the wearable electronic device to a user's clothing is unattached; and
detecting that the wearable electronic device is stationary, wherein the determining that the wearable electronic device is in the misplaced condition is in response to the sensing and the detecting.

5. (canceled)

6. The method of claim 1 further comprising:
selecting the alert from a plurality of alerts, wherein the plurality of alerts comprise one or more of sounding an audible alarm at the wearable electronic device, transmitting a text message from the wearable electronic device to another device, transmitting a telephone call from the wearable electronic device to another device, transmitting an email message from the wearable electronic device to another device, and displaying a visible light at the wearable electronic device.

7. The method of claim 6 further comprising:
repeating at least one of the selected alerts.

8. A wearable electronic device comprising:
a device body;
one or more processors within the device body;
a memory coupled to at least one of the processors and also within the device body;
a power supply within the device power that supplies power to the processors; and
a set of instructions stored in the memory and executable by at least one of the processors to:
determine that a wearable electronic device is in a misplaced condition. wherein the determination includes a detection that the wearable electronic device is stationary for at least a predetermined amount of time; and
transmit an alert regarding the misplaced condition, wherein the alert includes displaying a visible light beacon at the wearable electronic device.

9. The wearable electronic device of claim 8 further comprising instructions executable by at least one of the processors to:
identify a geographic location of the wearable electronic device in response to the wearable electronic device becoming stationary;
compare the identified geographic location with one or more predetermined acceptable geographic locations where a stationary device is acceptable;
inhibit the misplaced condition in response to the wearable electronic device's identified geographic location corresponding to one of the predetermined acceptable geographic locations; and establish the misplaced condition in response to the wearable electronic device's identified geographic location failing to correspond to one of the predetermined acceptable geographic locations.

10. The wearable electronic device of claim 8 further comprising instructions executable by at least one of the processors to:
sense that the wearable electronic device has been removed from a device holder; and
detect that the wearable electronic device is stationary, wherein the determining that the wearable electronic device is in the misplaced condition is in response to the sensing and the detecting.

11. The wearable electronic device of claim 8 further comprising instructions executable by at least one of the processors to:
sense that a clip used to attach the wearable electronic device to a user's clothing is unattached; and
detect that the wearable electronic device is stationary, wherein the determining that the wearable electronic device is in the misplaced condition is in response to the sensing and the detecting.

12. (canceled)

13. The wearable electronic device of claim 8 further comprising instructions executable by at least one of the processors to:
select the alert from a plurality of alerts, wherein the plurality of alerts comprise one or more of sounding an audible alarm at the wearable electronic device, transmitting a text message from the wearable electronic device to another device, transmitting a telephone call from the wearable electronic device to another device, transmitting an email message from the wearable electronic device to another device, and displaying a visible light at the wearable electronic device.

14. The wearable electronic device of claim 13 further comprising instructions executable by at least one of the processors to:
repeat at least one of the selected alerts.

15. A computer program product comprising:
a tangible non-transitory computer readable storage medium comprising a set of computer instructions, the computer instructions effective to:
determine that a wearable electronic device is in a misplaced condition, wherein the determination includes a detection that the wearable electronic device is stationary for at least a predetermined amount of time; and
transmit an alert regarding the misplaced condition, wherein the alert includes displaying a visible light beacon at the wearable electronic device.

16. The computer program product of claim 15 further comprising instructions executable by at least one of the processors to:
identify a geographic location of the wearable electronic device in response to the wearable electronic device becoming stationary;
compare the identified geographic location with one or more predetermined acceptable geographic locations where a stationary device is acceptable;
inhibit the misplaced condition in response to the wearable electronic device's identified geographic location corresponding to one of the predetermined acceptable geographic locations; and
establish the misplaced condition in response to the wearable electronic device's identified geographic location failing to correspond to one of the predetermined acceptable geographic locations.

17. The computer program product of claim 15 further comprising instructions executable by at least one of the processors to:
sense that the wearable electronic device has been removed from a device holder; and
detect that the wearable electronic device is stationary, wherein the determining that the wearable electronic device is in the misplaced condition is in response to the sensing and the detecting.

18. The computer program product of claim 15 further comprising instructions executable by at least one of the processors to:
sense that a clip used to attach the wearable electronic device to a user's clothing is unattached; and
detect that the wearable electronic device is stationary, wherein the determining that the wearable electronic device is in the misplaced condition is in response to the sensing and the detecting.

19. (canceled)

20. The computer program product of claim 15 further comprising instructions executable by at least one of the processors to:
select the alert from a plurality of alerts, wherein the plurality of alerts comprise one or more of sounding an audible alarm at the wearable electronic device, transmitting a text message from the wearable electronic device to another device, transmitting a telephone call from the wearable electronic device to another device, transmitting an email message from the wearable electronic device to another device, and displaying a visible light at the wearable electronic device; and
repeat at least one of the selected alerts.
